(19) United States
(12) Patent Application Publication
(10) Pub. No.: US 2010/0051537 A1
(43) Pub. Date: Mar. 4, 2010

(54) Filter Element with Glued-On Terminal Disk

(75) Inventors: Dieter Amesoeder, Bietigheim-Bissingen (DE); Dieter Schreckenberger, Marbach (DE)

Correspondence Address: Mann+Hummel GMBH;Department VR-P, Hindenburgstr. 45, Ludwigsburg, 71638, DE

(73) Assignee: MANN+HUMMEL GMBH, Ludwigsburg (DE)

(21) Appl. No.: 12/445,772

(22) PCT Filed: Oct. 18, 2007
(86) PCT No.: PCT/EP2007/061120

§ 371 Date: Nov. 2, 2009

(30) Foreign Application Priority Data
Oct. 18, 2006 (DE) 20 2006 016102.3

(51) Int. Cl. B01D 27/06

(52) U.S. Cl. 210/493.2

(57) ABSTRACT

A filter element (1) with a hollow-cylindrical star-shaped folded filter medium (2) and glued-on terminal disks (3) on at least one of the end faces of the filter medium (2) is proposed in which the respective end face contour of the filter medium (2), the intermediate space between the filter medium (2) and the respective terminal disks (3), and/or the respective contour of the terminal disk (3) is designed, for example, by slants (8, 9) or spacers (10), such that at the inner diameter of the hollow-cylindrical star-shaped folded filter medium (2) an enlarged gap for an adhesive connection (4) between the filter medium (2) and the respective terminal disks (3) is provided so that the folds at the inner diameter are thus safely adhesively connected.

### TECHNICAL FIELD

The invention is based on a filter element for filtering gases or liquids, comprising a hollow-cylindrical star-shaped folded filter medium that has glued-on terminal disks at its end faces according to the features of the preamble of the independent claim.

DE 102004063346 A—Jul. 13, 2006—discloses, for example, that a hollow-cylindrical filter element with a star-shaped folded filter medium of nonwoven or paper can be glued with its end faces to a terminal disk, respectively, that is made of plastic or metal.

Such terminal disks are required in order to insert the filter medium made of relatively soft material in a seal-tight way into a filter housing of a filter arrangement and, in this connection, to achieve a safe separation of the side of the filter element where the unfiltered medium flows in and the side where the filtered medium flows out.

Furthermore, a filter arrangement is disclosed in DE 4206519 A in which such a star-shaped folded hollow-cylindrical filter element is provided at the end faces with seal-tightly covering plates, for example made of metal, or with a film-shaped sealing material. These plate-shaped or film-shaped seals project radially inwardly with a certain quantity into the inner cylinder so that also a sealing action relative to a central tube is achievable.

The afore described filter elements often exhibit leaks in the area of the adhesive connection of the end face of the star-shaped folded filter medium relative to the respective terminal disk so that particles to be filtered out can pass from the unfiltered side or dirt side of the filter element to the clean side. Since these filter elements with their fold arrangement in general are designed such that the receiving capacity of the filter element achieves an optimum, the folds are often positioned very tightly next to each other and this is especially the case at the inner diameter as a result of the star-shaped fold arrangement of the filter element, At these locations there are therefore often leaks because the adhesive is almost completely displaced at the tightly folded locations at the inner diameter when the filter medium is pressed in and, therefore, as a result of the very tightly positioned folds, the adhesive cannot flow between the folds in order to enclose them tightly.

### SUMMARY OF THE INVENTION

The invention concerns a filter element with a hollow-cylindrical star-shaped folded filter medium and glued-on terminal disks at least at one end face of the filter medium. In order to achieve a safe sealing action of the filter element also at the inner diameter of the hollow-cylindrical star-shaped folded filter medium, the respective end face contour of the filter medium, the intermediate space between the filter medium and the respective terminal disk, and/or the respective contour of the terminal disk is designed in accordance with the present invention in an advantageous manner such that, in comparison to the outer diameter of the filter medium, at the inner diameter of the hollow-cylindrical star-shaped folded filter medium a larger volume of adhesive can be arranged between the filter medium and the respective terminal disks by providing a greater gap for the adhesive connection.

With the invention it is achieved in a simple way that in the area of the inner diameter of the filter medium, also referred to as filter bellows, between the terminal disk and the filter medium sufficient space is provided in order to allow a sufficient amount of adhesive to remain after application of the terminal disk. In a curing process, the adhesive can then creep also into the folds at the inner diameter and in this way can adhesively connect them and seal them.

In a first embodiment, the respective end face contour of the filter medium is designed advantageously in such a way that a radially inwardly extending slant is provided that leads to a greater gap for the adhesive connection and thus to a greater adhesive volume at the inner diameter after application of the terminal disk.

According to a second embodiment the contour of the respective terminal disk that is facing the end face of the filter medium is designed in a simple way such that a radially inwardly extending slant is provided that then also leads to a greater gap for the adhesive connection or to a greater adhesive volume at the inner diameter.

In accordance with a third embodiment, it is furthermore also advantageous when, for example, between the respective end face of the filter medium and the respective terminal disk at the outer diameter of the filter medium, a spacer that extends only partially across the end face of the filter medium is arranged; this also leads to a greater gap for the adhesive connection or a greater adhesive volume at the inner diameter.

Special advantages can be achieved with the filter element according to the invention when the filter element is a component of a filter arrangement for fuel in a motor vehicle because in this application the seal tightness of the filter arrangement is of special importance. In particular in motor vehicles with an injection system for fuel that operates at high pressures and with sensitive fuel injectors, particles that remain within the fuel by bypassing the filter element can cause great damage.

### BRIEF DESCRIPTION OF THE DRAWINGS

Embodiments of the invention will be explained with the aid of the drawings. It is shown in:

FIG. 1 a section view of a conventional filter element with glued-on terminal disks at the end faces of the filter medium;

FIG. 2 a plan view onto the filter element according to FIG. 1 with the star-shaped folding of the filter medium partially made visible;

FIG. 3 a partial section view of the area of the end face contact of the terminal disk on the filter medium where, in accordance with the prior art, at the inner diameter almost no adhesive penetrates into the filter medium;

FIG. 4 a partial section view of the area of the end face contact of the terminal disk on the filter medium where, according to a first inventive embodiment, the filter medium is provided with a slant;

FIG. 5 a partial section view of the area of the end face contact of the terminal disk on the filter medium where, in accordance with a second embodiment, the terminal disk is provided with a slant; and

FIG. 6 a partial section view of the area of the end face contact of the terminal disk on the filter medium where, according to a third embodiment, a spacer is arranged.

### DETAILED DESCRIPTION

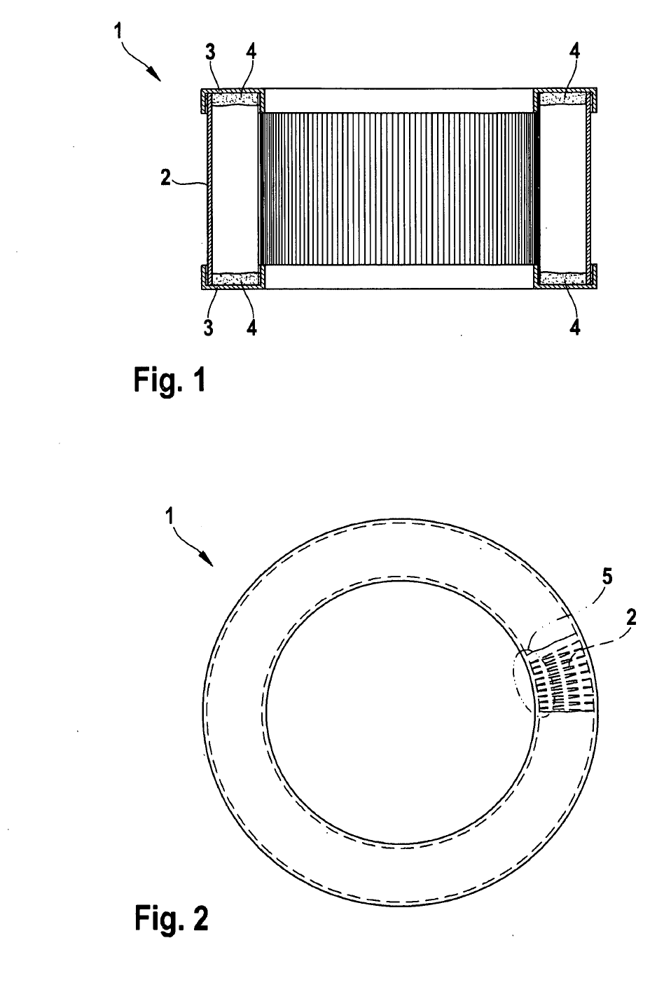

In FIG. 1, a conventional configuration of a filter element 1 with a hollow-cylindrical star-shaped folded filter medium 2 is illustrated. At the end faces terminal disks 3 are attached to the filter medium 2, for example, made of paper or nonwoven, with an adhesive indicated at the respective connecting locations by an adhesive connection 4. FIG. 2 shows in a plan view onto the filter element 1 in a detail 5 schematically the fold arrangement of the filter medium 2, also in a plan view, so that very tightly positioned folds at the inner diameter of the filter medium 2 can be seen.

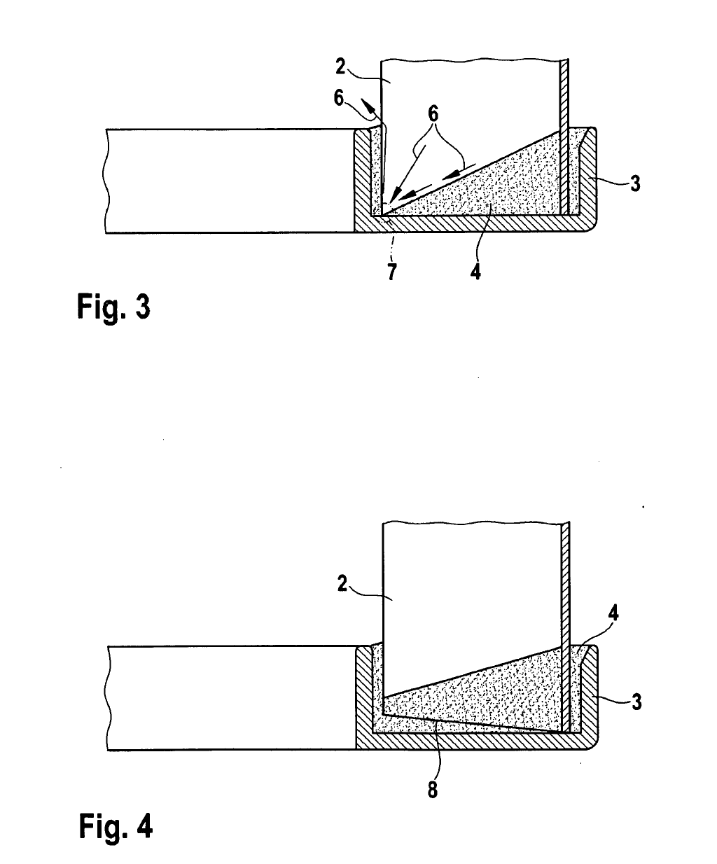

From the partial section view according to FIG. 3 it can be seen that from the area of end face contact of the terminal disk 3 on the filter medium 2, for the conventional arrangement of the terminal disk 3 according to the prior art, at the inner diameter almost no adhesive penetrates into the filter medium. With arrows 6 it is indicated that particles, for example, when filtering fuel for a motor vehicle, can pass through the area 7 at the inner diameter of the filter medium 2 because in this area almost no adhesive of the adhesive connection 4 has penetrated as a result of the tightly positioned folds (compare area 5 of FIG. 2). Accordingly, a safe separation of the side of the filter element 1, where the unfiltered fuel flows in from the exterior, from the side, where the filtered fuel flows out into a central tube at the inner diameter of the filter element 1, is not possible.

In a first embodiment according to the invention according to FIG. 4, the respective end face contour of the filter medium 2 that rests against the terminal disk 3 has a radially inwardly extending slant 8 that provides a greater volume of adhesive of the adhesive connection 4 at the inner diameter after application of the terminal disk 3. In a curing process for the adhesive of the adhesive connection 4 the adhesive can creep into the folds of the filter medium 2 also at the inner diameter and can therefore adhesively connect and seal them so that a particle flow 6, as indicated in FIG. 3, can no longer occur.

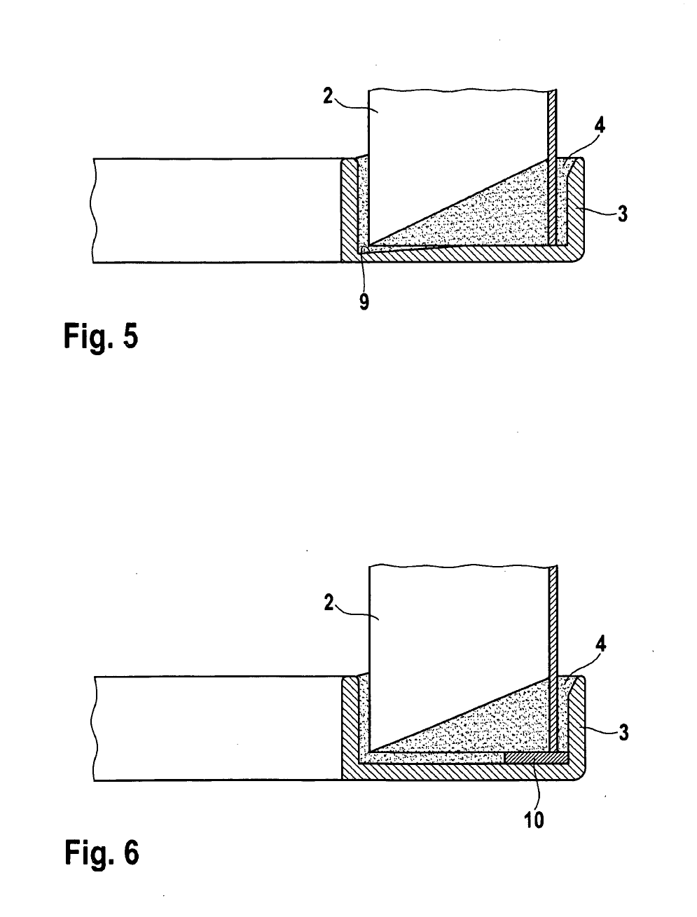

FIG. 5 shows a second embodiment of the invention in which the respective contour of the respective terminal disk 3 facing the respective end face of the filter medium 2 has a radially inwardly extending slant 9 that also leads to a greater adhesive volume at the inner diameter, as in the embodiment of FIG. 3.

A third embodiment of the invention according to FIG. 6 has between the respective end face of the filter medium 2 and the respective terminal disk 3 at the outer diameter of the filter medium 2 a spacer 10 that extends only partially across the end face of the filter medium 2; this also has the result that a greater volume of adhesive of the adhesive connection 4 is present at the inner diameter of the filter medium 2 and, therefore, an effective adhesive connection and sealing action of the filter medium 2 are realized also at the inner diameter.

1. A filter element (1) with a hollow-cylindrical star-shaped folded filter medium (2) and glued-on terminal disks (3) on at least one of end face of the filter medium (2), characterized in that at least one of (a respective end face contour of the filter medium (2), an intermediate space between the filter medium (2) and the respective terminal disks (3), and the respective contour of the terminal disk (3)) is designed such that at an inner diameter of the hollow-cylindrical star-shaped folded filter medium (2) an enlarged gap for an adhesive connection (4) between the filter medium (2) and the respective terminal disks (3) is provided.

2. The filter element according to claim 1, characterized in that the respective end face contour of the filter medium (2) is designed in such a way that a radially inwardly extending slant (8) is provided and configured to establish the enlarged gap for adhesive connection (4) at the inner diameter.

3. The filter element according to claim 1, characterized in that the respective contour of the respective terminal disk (3) facing the end face of the filter medium (2) is designed such that a radially inwardly extending slant (9) is provided and configured to establish the enlarged gap for the adhesive connection (4) at the inner diameter.

4. The filter element according to claim 1, characterized in that between the respective end face of the filter medium (2) and the terminal disk (3) at an outer diameter of the filter medium (2) a spacer (10) is arranged that at least partially extends across the end face of the filter medium (2) establishing the enlarged gap for the adhesive connection (4) at the inner diameter.

5. The filter element according to claim 1, characterized in that the filter element (1 ) is a component of a filter arrangement for filtering fuel in a motor vehicle.

6. The filter element according to claim 1, characterized in that the filter medium (2) is produced from paper or nonwoven.
